(19) United States
(12) Patent Application Publication
(10) Pub. No.: US 2008/0160820 A1
(43) Pub. Date: Jul. 3, 2008

(54) Electrical terminal

(76) Inventor: Limin Deng, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/976,771

(22) Filed: Oct. 29, 2007

(30) Foreign Application Priority Data
Dec. 30, 2006 (CN) 200620155550.1

(51) Int. Cl. H01R 13/631

(52) U.S. Cl. 439/358

(57) ABSTRACT

An electrical terminal for gripping a solder includes a body, an elastic arm extending from the body, which has a contact at the end of the elastic arm, and a welding portion extending downwardly from the body, wherein the welding portion includes a baffle and at least two gripping pieces, the baffle extends from the underside of the body and abuts against the solder, and the gripping pieces extend bendly from the baffle and grip the solder. The present invention ensures the solder is gripped within the welding portion in order to decrease the amount of impurities interfused in the soldering fluid, and prevents the soldering fluid of the electrical terminals from blending with each other when the solder is welded on the printed circuit board. Therefore the solder is kept clear to improve the quality of the electrical connection and strengthen the welding bond.

### BACKGROUND OF THE INVENTION

1. Field of the Invention

The present invention relates to an electrical terminal.

2. Description of Prior Art

An electrical connector is connected with a CPU and a PCB (printed circuit board). In general, there are two kinds of structures for electrical connectors, one which uses an inserting pin and another which uses a surface mounted terminal. As manufacturing techniques have developed rapidly over recent years, the planting ball technique has become more commonly used throughout the connector industry to put the surface mounted terminal in widespread use.

Two Chinese patents (No: 03205304.5 and No: 01280419.3) disclose a structure for the planting ball of a connector. The present structure is to weld the solder at the end of the terminal via heating the solder.

The prior arts described above suffer from the following defect:

The solder is first fixed through a welding process at the end of the terminal. It is then necessary to heat the solder again when welding the terminal onto the PCB. Due to the twice welding process, the soldering fluid of the adjacent terminals after heating often blend together, thereby causing manufacturing defect and increasing costs.

Alternatively, the impurities can be interfused in the solder when the solder is fused. Because the welding process has been performed many times, many impurities are interfused in the solder, which makes the solder difficult to freeze and apt to break.

The inventor of the present invention recognizes the above shortage should be corrected and special effort has been paid to research this field. The present invention is presented with reasonable design and good effect to resolve the above problems.

### SUMMARY OF THE INVENTION

An object of the present invention is to provide an electrical terminal, which can fix the solder in order to prevent the problems caused by repetitive welding.

In order to achieve the above objects, the present invention provides an electrical terminal for gripping a solder. The electrical terminal includes a body, an elastic arm extending from the body, which has a contact at the end of the elastic arm, and a welding portion extending downwardly from the body. The welding portion includes a baffle and at least two gripping pieces. The baffle extends from the underside of the body and abuts against the solder, and the gripping pieces extend bendly from the baffle and grip the solder.

Compared to the prior art, the present invention grips the solder within the welding portion thereby decreasing the amount of impurities that become interfused in the soldering fluid, thereby avoiding the soldering fluid of the electrical terminals from blending with each other when the solder is welded onto the printed circuit board. Therefore the solder is kept clear and increases the quality of the electrical connection and strengthens the welding bond.

In order to better understand the characteristics and technical contents of the present invention, a detailed description thereof will be made with reference to the accompanying drawings. However, it should be understood that the drawing and the description are illustrative and should not be used to limit the scope of the present invention.

### BRIEF DESCRIPTION OF THE DRAWINGS

The present invention can be fully understood from the following detailed description and preferred embodiment with reference to the accompanying drawings, in which:

FIG. 1 is an exploded perspective view of the first embodiment according to the present invention;

FIG. 2 is an assembled perspective view of the first embodiment according to the present invention;

FIG. 3 is another view of FIG. 2;

FIG. 4 is an exploded perspective view of the second embodiment according to the present invention;

FIG. 5 is an assembled perspective view of the second embodiment according to the present invention; and

FIG. 6 is another view of FIG. 5.

### DETAILED DESCRIPTION OF THE INVENTION

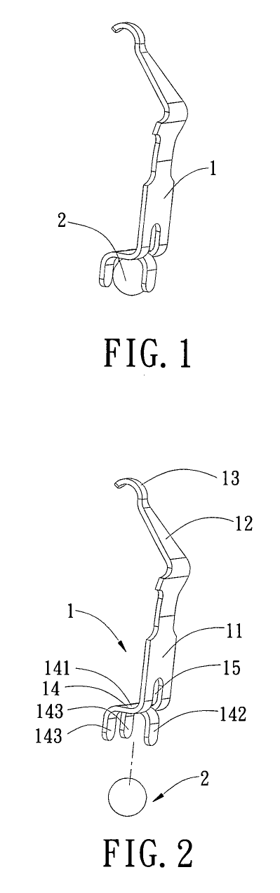

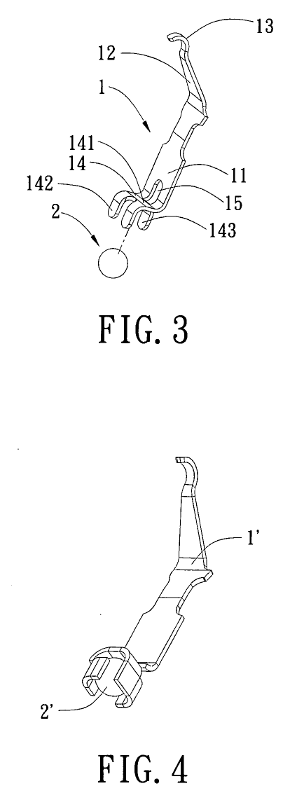

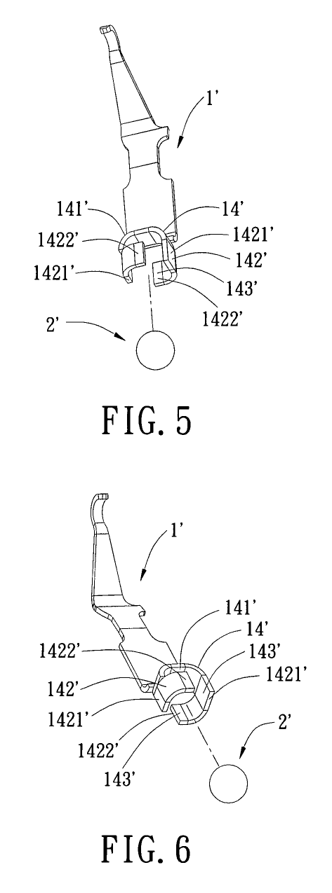

With reference to FIGS. 1 to 3, the present invention provides an electrical terminal 1 disposed on the IC socket (omitted in the drawing) for connecting with the printed circuit board (omitted in the drawing).

The electrical terminal 1 includes a body 11, an elastic arm 12 and a welding portion 14. The elastic arm 12 extends upwardly obliquely from the body 11. The end of the elastic arm 12 has a contact 13 disposed thereon. The welding portion 14 extends downwardly from the body 11.

The welding portion 14 includes a baffle 141 and three gripping pieces 142. The baffle 141 extends from the underside of the body 11 and abuts against a solder 2. The solder 2 can be a tin ball. The three gripping pieces 142 extend respectively from the two sides of baffle 141 for gripping the solder 2. Each gripping piece 142 has at least one gripping portion 143. That is, the three gripping pieces 142 have at least three gripping portions 143 for gripping the solder 2. The underside of the body 11 is formed with the gripping piece 14 via a stamping process and thereby a clearance hole 15 is formed via the join between the body 11 and the welding portion 14. The shape of the clearance hole 15 is the same as the shape of the gripping piece 142.

During the assembling process, the electrical terminal 1 is inserted in the IC socket. The solder 2 is disposed within the welding portion 14 and the baffle 141 abuts against the topside of the tin ball 2 for preventing a siphoning phenomenon in the welding process. The three gripping pieces grip the protruding side of the solder 2 for fixing the solder 2.

The solder 2 is gripped within the welding portion in order to decrease the amount of impurities interfused in the soldering fluid, and to avoid the soldering fluid of the adjacent terminals 1 from blending together when the solder 2 is being welded onto the printed circuit board. Therefore the solder 2 is kept clear to improve the quality of the electrical connection and strengthen the welding bond.

The second embodiment of the present invention is not the same as the first embodiment, as is described below. The welding portion 14′ has two gripping pieces 142′ disposed thereon. The two gripping pieces 142′ extend bendly from the two sides of the baffle 141′. Each of the gripping pieces 142′ includes a first gripping piece 1421′ and a second gripping piece 1422′. The first gripping piece 1421′ extends directly from the baffle 141′ and the second gripping piece 1422′ extends bendly from the first gripping piece 1421′. The first gripping piece 1421′ and the second gripping piece 1422′ are disposed perpendicular to each other. The two second gripping pieces 1422′ extend oppositely to each other. The first gripping piece 1421′ and the second gripping piece 1422′ are disposed respectively with at least one gripping portion 143′. That is the two gripping pieces 142′ have at least four gripping portions 143′ in total. The four gripping portions 143′ grip the solder 2′ firmly in order to achieve the same result as the first embodiment of the present invention.

Although the present invention has been described with reference to the foregoing preferred embodiments, it will be understood that the invention is not limited to the details thereof. Various equivalent variations and modifications may still occur to those skilled in this art in view of the teachings of the present invention. Thus, all such variations and equivalent modifications are also embraced within the scope of the invention as defined in the appended claims.

What is claimed is:

1. An electrical terminal for gripping a solder, comprising a body, an elastic arm extending from the body, which has a contact at the end of the elastic arm, and a welding portion extending downwardly from the body, wherein the welding portion comprises a baffle and at least two gripping pieces, the baffle extends from the underside of the body and abuts against the solder, and the gripping pieces extend bendly from the baffle and grip the solder.

2. The electrical terminal according to claim 1, wherein the gripping pieces have at least three gripping portions for gripping the solder.

3. The electrical terminal according to claim 2, wherein the at least three gripping pieces extend respectively from the baffle.

4. The electrical terminal according to claim 1, wherein the gripping pieces extend downward from the two opposite sides of the baffle.

5. The electrical terminal according to claim 4, wherein each of the gripping pieces includes a first gripping piece and second gripping piece, the first gripping piece extends directly from the baffle, and the second gripping piece extends bendly from the first gripping piece.

6. The electrical terminal according to claim 5, wherein the first gripping piece and the second gripping piece are perpendicular to each other.

7. The electrical terminal according to claim 5, wherein the two second gripping pieces extend oppositely from each other.

8. The electrical terminal according to claim 5, wherein the first gripping piece and the second gripping piece are disposed respectively with at least one gripping portion.

9. The electrical terminal according to claim 1, wherein the solder is a tin ball.

10. The electrical terminal according to claim 1, wherein the elastic arm extends obliquity from the body.
